(19) United States
(12) Patent Application Publication
(10) Pub. No.: US 2022/0375004 A1
(43) Pub. Date: Nov. 24, 2022

(54) METHOD FOR AUTOMATED BUFFER ZONE MANAGEMENT

(71) Applicant: BASF Agro Trademarks GmbH, Ludwigshafen am Rein (DE)

(72) Inventors: Nicolas WERNER, Köln (DE); Mirwaes WAHABZADA, Köln (DE); Ole JANSSEN, Köln (DE)

(21) Appl. No.: 17/774,646

(22) PCT Filed: Nov. 6, 2020
(86) PCT No.: PCT/EP2020/081359

§ 371 Date: May 5, 2022

(30) Foreign Application Priority Data
Nov. 8, 2019 (EP) 19208118.0

(51) Int. Cl. G06Q 50/02; G06F 16/29; G06V 20/10

(52) U.S. Cl. CPC G06Q 50/02; G06F 16/29; G06V 20/188

(57) ABSTRACT

A computer-implemented method for generating an application map for treating a field with an agricultural equipment comprising the following steps: a) providing a land cover map relating to a field to be treated; b) receiving master data selected from the group consisting of: regulatory data, machine data, field data, elevation data, c) optionally initiating the determination of, and/or determining preliminary buffer zones as a further layer to the land cover map based on the master data, d) optionally receiving validation information selected from the group consisting of: (i) validation information relating to the field to be treated or relating to the land cover map, (ii) validation information relating to master data selected from the group consisting of regulatory data, machine data, field data, elevation data, and (iii) validation information relating to preliminary buffer zones, e) initiating the determination of, and/or determining buffer zones as a further layer to the land cover map based on the master data and—optionally—based on the validation information; and f) initiating the generation of, and/or generating an application map specifying areas for treating the field with an agricultural equipment, wherein the application map is based on the buffer zones.

### FIELD OF THE INVENTION

The present invention relates to a method for generating an application map for treating a field with an agricultural equipment and the use of an application map in which buffer zones have been specified according to regulatory requirements. Moreover, the present invention also relates to an agricultural equipment controlled by control data and/or a control map provided by a method according to the present invention.

### BACKGROUND OF THE INVENTION

In the prior art, it is common practice that most of the crop protection products are applied across the whole field. According to regulatory requirements, crop protection products are not allowed to be applied for example in a specific distance to water resources (river, stream, lake, pond, well) or to locations where specific protected animal or plant species are living, which is usually referred to as the buffer zone. Typically, it is very complicated or time-consuming for a user to perform an accurate analysis of the field to determine where the buffer zones are exactly located in the field. In addition, it is difficult to control and move an agricultural equipment in such a way that the field is only treated where the treatment is allowed according to regulatory requirements.

Furthermore, in case standard maps are applied directly as application maps, there is a certain likelihood that some parts of a field, such as a small pond or a small stream, are not indicated in the standard maps. Using such standard maps directly as application maps would potentially result in the case that the user performs a unallowed treatment within the buffer zone relating to the small pond or the small stream. Such cases have to be avoided.

### SUMMARY OF THE INVENTION

In the view of the above, it is an object of the present invention to provide a method for generating an application map for treating a field with an agricultural equipment. A further object of the present invention is to provide method that can be carried out most automatically and can provide a user with control data or a control map for an agricultural equipment in a simple and fast manner.

These and other objects, which become apparent upon reading the following description, are solved by the subject matter of the independent claims. The dependent claims refer to preferred embodiments of the invention.

According to the invention, a computer-implemented method for generating an application map for treating a field with an agricultural equipment is provided comprising the following steps:
a) (302) providing a land cover map relating to a field to be treated;
b) (304) receiving master data selected from the group consisting of: regulatory data, machine data, field data, elevation data;
e) (310) initiating the determination of, and/or determining buffer zones as a further layer to the land cover map based on the master data; and
f) (312) initiating the generation of, and/or generating an application map specifying areas for treating the field with an agricultural equipment, wherein the application map is based on the buffer zones.

According to another preferred embodiment of the invention, a computer-implemented method for generating an application map for treating a field with an agricultural equipment is provided comprising the following steps:
a) (302) providing a land cover map relating to a field to be treated;
b) (304) receiving master data selected from the group consisting of: regulatory data, machine data, field data, elevation data;
c) (306) optionally initiating the determination of, and/or determining preliminary buffer zones as a further layer to the land cover map based on the master data;
d) (308) optionally receiving validation information selected from the group consisting of:
   (i) validation information relating to the field to be treated or relating to the land cover map,
   (ii) validation information relating to master data selected from the group consisting of regulatory data, machine data, field data, elevation data, and
   (iii) validation information relating to preliminary buffer zones;
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

According to another preferred embodiment of the invention, a computer-implemented method for generating an application map for treating a field with an agricultural equipment is provided comprising the following steps:
a) (302) providing a land cover map relating to a field to be treated;
b) (304) receiving master data selected from the group consisting of: regulatory data, machine data, field data, elevation data;
c) (306) optionally initiating the determination of, and/or determining preliminary buffer zones as a further layer to the land cover map based on the master data;
d) (308) receiving validation information selected from the group consisting of:
   (i) validation information relating to the field to be treated or relating to the land cover map,
   (ii) validation information relating to master data selected from the group consisting of regulatory data, machine data, field data, elevation data, and
   (iii) validation information relating to preliminary buffer zones;
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

According to another preferred embodiment of the invention, a computer-implemented method for generating an application map for treating a field with an agricultural equipment is provided comprising the following steps:
a) (302) providing a land cover map relating to a field to be treated;
b) (304) receiving master data selected from the group consisting of: regulatory data, machine data, field data, elevation data,
d) (308) receiving validation information relating to the field to be treated or relating to the land cover map,
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

According to another preferred embodiment of the invention, a computer-implemented method for generating an application map for treating a field with an agricultural equipment is provided comprising the following steps:
a) (302) providing a land cover map relating to a field to be treated;
b) (304) receiving master data selected from the group consisting of: regulatory data, machine data, field data, elevation data;
d) (308) receiving validation information relating to master data selected from the group consisting of regulatory data, machine data, field data, elevation data;
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

According to another preferred embodiment of the invention, a computer-implemented method for generating an application map for treating a field with an agricultural equipment is provided comprising the following steps:
a) (302) providing a land cover map relating to a field to be treated;
b) (304) receiving master data selected from the group consisting of: regulatory data, machine data, field data, elevation data;
c) (306) initiating the determination of, and/or determining preliminary buffer zones as a further layer to the land cover map based on the master data;
d) (308) receiving validation information relating to preliminary buffer zones;
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

According to another preferred embodiment of the invention, a computer-implemented method for generating an application map for treating a field with an agricultural equipment is provided comprising the following steps:
a) (302) providing a land cover map relating to a field to be treated;
b) (304) receiving master data selected from the group consisting of: regulatory data, machine data, field data, elevation data;
c) (306) initiating the determination of, and/or determining preliminary buffer zones as a further layer to the land cover map based on the master data;
d) (308) receiving validation information relating to preliminary buffer zones;
e) (310) initiating the determination of, and/or determining buffer zones based on the preliminary buffer zones and based on the validation information relating to preliminary buffer zones; and
f) (312) initiating the generation of, and/or generating an application map specifying areas for treating the field with an agricultural equipment, wherein the application map is based on the buffer zones.

According to another preferred embodiment of the invention, the validation information is validation information relating to the field to be treated or relating to the land cover map.

According to another preferred embodiment of the invention, the validation information is validation information relating to the master data selected from the group consisting of regulatory data, machine data, field data, elevation data.

According to another preferred embodiment of the invention, the validation information is validation information relating to regulatory data.

In the step a) of the method of the invention (302), a land cover map relating to a field to be treated is provided.

The field to be treated is any field which can be treated with an agricultural input. Agricultural inputs include crop protection products, seeds (including genetically-modified seeds), plants (including genetically-modified plants), and water used for irrigation. Crop protection products include any chemical compounds and microorganisms used for agriculture, including but not limited to fungicides, herbicides, insecticides, nematicides, plant growth regulators, fertilizers, crop nutrients, nitrification inhibitors, denitrification inhibitors, urease inhibitors, soil and soil additives. In one preferred embodiment, the agricultural input is a crop protection product, and most preferably a fungicide, herbicide, insecticide, and/or nematicide. In another preferred embodiment, the agricultural input is a seed, more preferably a genetically-modified seed.

The land cover map can be any map showing the differences in the land cover, i.e. showing the geographical locations of e.g. water (for example river, stream, lake, pond), fields, forests, grassland, housing, streets etc. Preferably, the land cover map shows the geographical locations of sensitive areas. Sensitive areas are those areas for which there are specific restrictions regarding the application of agricultural inputs, for example restrictions due to regulatory requirements, product stewardship requirements, requirements related to biodiversity or specific biodiversity measures (for example flower strip or uncultivated areas within the field) or requirements related to the agricultural equipment. The land cover map relating to the field to be treated particularly includes the surroundings of this field. More preferably, the land cover map is generated based on a least one of the following categories of data: general map data, remote sensing data and user map data.

General map data can be any data related to geographical locations and maps. Map data can be for example data from commercially available maps, open source maps, or maps provided by the government.

Remote sensing data can be any imagery data obtained by a remote sensor or flying object, for example satellites, aircrafts, helicopters, drones. Preferably, remote sensing data are imagery data obtained by satellites.

User map data can be any data received from the user relating to the land cover map or relating to the field to be treated.

Most preferably, the land cover map is generated via a land cover classification algorithm (in the following referred to as “LCC algorithm”) based on a least one of the following categories of data: General map data, remote sensing data, and user map data. It is preferred that the LCC algorithm is based on the results of a machine-learning algorithm, e.g. neural networks. In other words, it is preferred that the general map data, and/or the remote sensing data, and/or the user map data, are fed to a trained machine-learning algorithm to classify the land cover relating to the field to be treated and of the surroundings of the field to be treated. The machine-learning algorithm preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that are higher by many orders of magnitude.

If necessary, the field to be treated and its surroundings can be divided into suitable segments so that an accordingly high resolution can be provided suitable for the analysis by an LCC algorithm. From a geographical point of view, the land cover map covers at least the area of a field to be treated, which may be a “complete” field or only part of a field. Finally, a land cover map may also comprise several geographically separate individual fields.

In the step b) of the method of the invention (304), master data selected from the group consisting of regulatory data, machine data, field data, and elevation data are received.

Preferably the master data include at least regulatory data and machine data.

More preferably the master data include at least regulatory data and field data.

Most preferably, the master data include regulatory data and machine data and field data.

Regulatory data can be any data which imposes specific restrictions related to the application of agricultural inputs. In one preferred embodiment, regulatory data include data on the legal framework, data on regulations relating to the application of agricultural inputs, data on distance regulations for agricultural inputs, data related to measures of product stewardship, data related to biodiversity or specific biodiversity measures (for example flower strip or uncultivated areas within the field). For such distance regulations stipulate a specific distance to water resources (e.g. river, stream, lake, pond, well) or to locations where specific protected animal or plant species are living. In one preferred embodiment, regulatory data are country-specific, region-specific or location-specific data. In one preferred embodiment, regulatory data are also specific for the agricultural input, especially specific for the crop protection product to be used.

Machine data can be any data relating to the agricultural equipment.

The term agricultural equipment is to be understood broadly and comprises any land or air supported device/machine suitable to treat a field by applying an agricultural input. However, the agricultural equipment is preferably a spraying machine with which preferably agricultural inputs (such as crop protection products) can be applied to the field. In addition or alternatively, an agricultural equipment is a mechanical/electrical device for mechanically or electrically removing weed/pest infestation from the field. In addition or alternatively, an agricultural equipment is a mechanical/electrical device for spreading or inserting seeds on/into the soil.

Machine data include but are not limited to data related to tractor type, terminal type, nozzle type and corresponding drift reduction category, sprayer type, seeder type, etc.

The field data include any data relating to the field to be treated, including data on the species, growth stages and biomass of the crops planted on this field, weather data, data related to the soil type, data related to drainage and irrigation, data on the historic treatments of this field, data related to the planned treatment of this field, for example the time of the planned treatment. Treatment includes application of agricultural inputs as well as other mechanical treatment such as tilling.

The elevation data include any data relating to the topographic characteristics (such as slope) of the field to be treated.

In the optional step c) of the method of this invention (306), preliminary buffer zones as a further layer to the land cover map are determined based on the master data, and/or such determination of preliminary buffer zones is initiated. In another preferred embodiment, preliminary buffer zones as a further layer to the land cover map are determined based on the master data and on validation information relating to the field to be treated or relating to the land cover map, and/or such determination of preliminary buffer zones is initiated. In another preferred embodiment, preliminary buffer zones as a further layer to the land cover map are determined based on the master data and on validation information relating to the master data, and/or such determination of preliminary buffer zones is initiated.

The preliminary buffer zones are preferably shown as surroundings around sensitive areas, wherein these surroundings for example have to fulfil certain regulatory requirements (especially distance requirements for the application of plant protection agents such as pesticides, fungicides, herbicides, insecticides).

The preliminary buffer zones as a further layer to the land cover map are determined using the master data and the validation information, preferably in fully automated way via an algorithm. For example, if a specific agricultural input (with corresponding regulatory data related to this agricultural input) should be applied on the field to be treated using a specific agricultural equipment (with corresponding machine data) and, the preliminary buffer zone is calculated via retrieving the corresponding data from the master data (in this exemplary case machine data and regulatory data) and the corresponding data from the land cover map. Preferably, the preliminary buffer zones are shown on a user interface, such as a display of a mobile device (e.g. smartphone, tablet, control display of an agricultural equipment) or a display of a computer.

In another preferred embodiment, the preliminary buffer zones are those buffer zones which are not generated based on any validation information. In another preferred embodiment, preliminary buffer zones are those buffer zones which are not generated based on any validation information relating to preliminary buffer zones.

In the optional step d) of the method of the invention (308), validation information selected from the group consisting of:

(i) validation information relating to the field to be treated or relating to the land cover map,
(ii) validation information relating to master data selected from the group consisting of regulatory data, machine data, field data, elevation data,
(iii) validation information relating to preliminary buffer zones, is received.

The validation information relating to the field to be treated or relating to the land cover map includes at least one of the following information:
1) information that all data relating to the field to be treated or all objects shown in the land cover map is correct;
2) information that specific data relating to the field to be treated have to be corrected;
3) information that specific objects in the land cover map have to be either added, or modified, or deleted; “modify” includes the editing of the shape/geometry of an object.

The validation information relating to master data includes at least one of the following information:
1) information that all master data are correct;
2) information that specific master data have to be corrected;
3) information that specific master data have to be either added, or modified, or deleted.

The validation information relating to regulatory data includes at least one of the following information:
1) information that all regulatory data are correct;
2) information that specific regulatory data have to be corrected;
3) information that specific regulatory data have to be either added, or modified, or deleted.

Particularly, regulatory data, e.g. distance requirements for the application of plant protection agents such as pesticides, fungicides, herbicides, insecticides, may be modified, especially in case the human user desires to conduct specific product stewardship measures or biodiversity measures.

The validation information relating to preliminary buffer zones includes at least one of the following information:
1) Information that all preliminary buffer zones and/or all objects shown in the preliminary buffer zones are correct;
2) Information that specific preliminary buffer zones and/or specific objects shown in the preliminary buffer zones have to be corrected;
3) Information that specific preliminary buffer zones and/or specific objects shown in the preliminary buffer zones have to be either added, or modified, or deleted.

“Object” means any visible or perceivable element, including but not limited to boundaries, colours, legends, signs or characters related to geographical locations or related to topographical characteristics. An object could be for example the boundary of the river.

Particularly, preliminary buffer zones may be modified, for example enlarged, especially in case the human user desires to conduct specific product stewardship measures or biodiversity measures.

The validation information can be inputted by the human user, or by a sensor or machine which is capable of automatically or semi-automatically obtaining data relating to the field to be treated or recognizing objects shown in the land cover map. In a preferred embodiment, the validation information can be inputted via a validation interface by the human user, or by a sensor or machine which is capable of automatically or semi-automatically obtaining data relating to the field to be treated or recognizing objects shown in the land cover map. The validation interface can be a user interface, or another kind of interface, including USB interface, sensor/computer interface, machine/computer interface etc.

In a preferred embodiment, the validation information is inputted by the human user, particularly via the user interface or in the user interface on which the buffer zones are displayed. In another preferred embodiment, the validation information is inputted by a sensor or machine which is capable of automatically or semi-automatically obtaining data relating to the field to be treated or recognizing objects shown in the land cover map. In yet another preferred embodiment, the validation information can also be used or processed as user map data, which are used for providing the land cover map. In yet another preferred embodiment, the validation information can also be used or processed as user map data, and which can be used for example for the training of the LCC algorithm.

In the step e) of the method of this invention (310), buffer zones as a further layer to the land cover map are determined based on the master data and based on the validation information, and/or such determination of buffer zones is initiated.

The buffer zones are preferably shown as surroundings around sensitive areas, wherein these surroundings for example have to fulfil certain regulatory requirements (especially distance requirements for the application of plant protection agents such as pesticides, fungicides, herbicides, insecticides).

The buffer zones as a further layer to the land cover map are determined using the master data and the validation information, preferably in fully automated way via an algorithm. For example, if a specific agricultural input (with corresponding regulatory data related to this agricultural input) should be applied on the field to be treated using a specific agricultural equipment (with corresponding machine data) and, the buffer zone is calculated via retrieving the corresponding data from the master data (in this exemplary case machine data and regulatory data) and the corresponding data from the land cover map. Preferably, the buffer zones are shown on a user interface, such as a display of a mobile device (e.g. smartphone, tablet, control display of an agricultural equipment) or a display of a computer.

In another preferred embodiment, in case preliminary buffer zones have been determined in optional step c), the buffer zones may alternatively be determined based on preliminary buffer zones and on validation information relating to the preliminary buffer zones.

In a preferred embodiment, buffer zones are specific for the agricultural input to be used.

In the step f) of the method of this invention (312), an application map is generated specifying areas for treating the field with an agricultural equipment, wherein the application map is based on the buffer zones. Alternatively, such generation of an application map is initiated.

In the application map, respective areas which need to be treated by the agricultural equipment or which must not be treated by the agricultural equipment are specified based on the results of the determination of the buffer zones. In a preferred embodiment, the application maps are supplemented with the buffer zones as surrounding for the corresponding sensitive areas. Notably, the term application map is to be understood broadly and includes also corresponding data sets with position coordinates that are not represented in a visual form.

Preferably, application maps can be specified for fiat rate application or variable rate application of agricultural inputs.

Preferably, application maps can be exported to the agricultural equipment such as a tractor terminal, which preferably uses the application maps for conducting the treatment—preferably the application of the agricultural input (e.g. crop protection products such as pesticides, herbicides, fungicides, insecticides).

Preferably, application maps can be used to enable treatment with automatic consideration of buffer zones, preferably the application of the agricultural input—e.g. crop protection products such as pesticides, herbicides, fungicides, insecticides—with automatic consideration of buffer zones.

Application maps are visualized with buffer zones and optionally additional data, for example a base map, on a web or mobile platform. A base map can be a web imagery service (e.g. Google maps or Bing maps) or a remote sensing image. A base map can be preferably used for the validation and/or verification of the buffer zones or of the land cover maps by the user.

The application maps can be downloaded in different formats and can be saved on an USB-stick or another portable stick. The USB-stick or the other portable stick can be connected to the terminal of the agricultural equipment and the map can be downloaded onto the terminal of the agricultural equipment.

In other words, the present invention allows to provide the user with an application map by means of an automatically executable method, which provides him the information where in the field he should not carry out a respective application, i.e. the user receives the information where he should not use certain agricultural inputs such as fungicides, herbicides and/or insecticides in the field and where he should not spread or insert any seeds. Thus, by means of the present invention, a significant reduction in crop protection products and a more sustainable, environmentally friendly and economically viable crop production can be provided.

It is preferred that the method further comprises the step of generating control data and/or a control map configured to be used for controlling an agricultural equipment. The control data/control map can, for example, be provided as control commands for the agricultural equipment, which can, for example, be read into a data memory of the agricultural equipment before the treatment of the field, for example, by means of a wireless communication interface, by a USB-interface or the like. In this context, it is preferred that the control data allow a more or less automated treatment of the field, i.e. that, for example, a sprayer automatically dispenses the desired herbicides and/or insecticides at the respective coordinates without the user having to intervene manually. It is particularly preferred that the control data also include control commands for driving off the field. It is to be understood that the present invention is not limited to a specific content of the control data, but may comprise any data needed to operate an agricultural equipment.

Preferably, the application map is divided in cells, preferably in polygon-shaped cells. In this respect, it is further preferred that the control data and/or control map is divided in cells corresponding to the cells of the application map and wherein the buffer zones are specified either with the cells or on the control map.

Preferably, the control data and/or control map comprises associated application rate data and/or data relating to the recommend agricultural input, such as recommended herbicides data, and/or insecticide data, and/or fungicide data. The provision of an appropriate recommendation can speed up the whole process as a user does not have to spend a lot of time identifying appropriate herbicides, insecticides, fungicides or mixtures he can use.

The present invention also relates to a use of a land cover map in a method for generating an application map for treating a field with an agricultural equipment as described above for determining buffer zones as a further layer to the land cover map. Moreover, the present invention also relates to a use of an application map in a method for generating an application map for treating a field with an agricultural equipment as described above for generating control data and/or a control map configured to be used for controlling an agricultural equipment, wherein the agricultural equipment is preferably a spraying machine, a seeding machine or a mechanical/electrical control device. Finally, the present invention relates to an agricultural equipment configured to be controlled by control data and/or a control map provided by a method for generating an application map for treating a field with an agricultural equipment as described above.

Finally, the present invention also relates to a computer program or computer program element configured to execute the above explained method, on an appropriate apparatus or system.

The computer program element might therefore be stored on a computer unit, which might also be part of an embodiment. This computing unit may be configured to perform or induce performing of the steps of the method described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the invention covers both, a computer program that right from the beginning uses the invention and computer program that by means of an update turns an existing program into a program that uses invention.

Further on, the computer program element might be able to provide all necessary steps to fulfill the procedure of an exemplary embodiment of the method as described above.

According to a further exemplary embodiment of the present invention, a computer readable medium, such as a CD-ROM, USB stick or the like, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

According to a further exemplary embodiment of the present invention, the present invention also relates to a computer system for generating an application map for treating a field with an agricultural equipment comprising:
1) a first interface component configured to provide a land cover map relating to a field to be treated,
2) a second interface component configured to receive master data selected from the group consisting of: regulatory data, machine data, field data, elevation data;
3) a fifth interface component configured to initiate the determination of, and/or a second system module configured to determine buffer zones as a further layer to the land cover map based on the master data and based on the validation information; and
4) a sixth interface component configured to initiate the generation of, and/or a third system module configured to generate an application map specifying areas for treating the field with an agricultural equipment, wherein the application map is based on the buffer zones.

According to a further exemplary embodiment of the present invention, the present invention also relates to a computer system for generating an application map for treating a field with an agricultural equipment comprising:
1) a first interface component configured to provide a land cover map relating to a field to be treated,
2) a second interface component configured to receive master data selected from the group consisting of: regulatory data, machine data, field data, elevation data;
3) optionally a third interface component configured to initiate the determination of, and/or a first system module configured to determine preliminary buffer zones as a further layer to the land cover map based on the master data;
4) optionally a fourth interface component configured to receive validation information selected from the group consisting of:
   (i) validation information relating to the field to be treated or relating to the land cover map,
   (ii) validation information relating to master data selected from the group consisting of regulatory data, machine data, field data, elevation data, and
   (iii) validation information relating to preliminary buffer zones;
5) a fifth interface component configured to initiate the determination of, and/or a second system module configured to determine buffer zones as a further layer to the land cover map based on the master data and based on the validation information; and
6) a sixth interface component configured to initiate the generation of, and/or a third system module configured to generate an application map specifying areas for treating the field with an agricultural equipment, wherein the application map is based on the buffer zones.

According to a further exemplary embodiment of the present invention, the present invention also relates to a computer system for generating an application map for treating a field with an agricultural equipment comprising:
1) a first interface component configured to provide a land cover map relating to a field to be treated,
2) a second interface component configured to receive master data selected from the group consisting of: regulatory data, machine data, field data, elevation data;
3) optionally a third interface component configured to initiate the determination of, and/or a first system module configured to determine preliminary buffer zones as a further layer to the land cover map based on the master data;
4) a fourth interface component configured to receive validation information selected from the group consisting of:
   (i) validation information relating to the field to be treated or relating to the land cover map,
   (ii) validation information relating to master data selected from the group consisting of regulatory data, machine data, field data, elevation data, and
   (iii) validation information relating to preliminary buffer zones;
5) a fifth interface component configured to initiate the determination of, and/or a second system module configured to determine buffer zones as a further layer to the land cover map based on the master data and based on the validation information; and
6) a sixth interface component configured to initiate the generation of, and/or a third system module configured to generate an application map specifying areas for treating the field with an agricultural equipment, wherein the application map is based on the buffer zones.

In one preferred embodiment, the first and fourth interface component may be one single interface component. In another preferred embodiment, the second and fourth interface component may be one single interface component. In another preferred embodiment, the first and second interface component may be one single interface component. In another preferred embodiment, the first and second and fourth interface component may be one single interface component. In another preferred embodiment, the first, second, third and fourth interface component may be one single interface component. In another preferred embodiment, the first, second, third, fourth, fifth, and sixth interface component may be one single interface component. In another preferred embodiment, the first, second, third, fourth, fifth, and sixth interface component may be two or three single interface components.

In one preferred embodiment, the first and second system module may be one single system module. In another preferred embodiment, the second and third system module may be one single system module. In another preferred embodiment, the first, second and third system module may be one single system module,

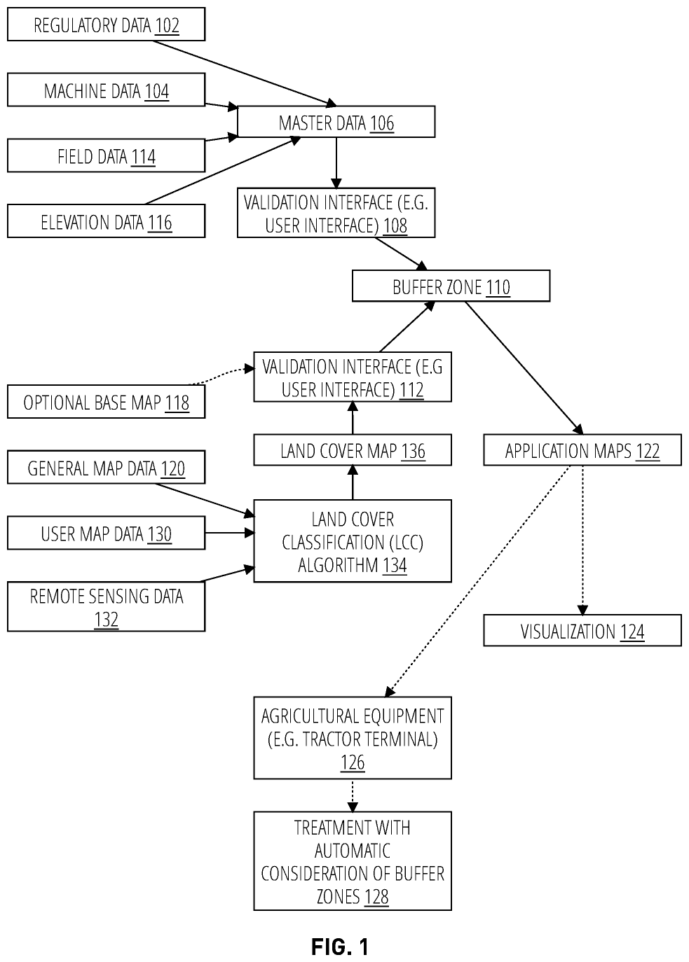

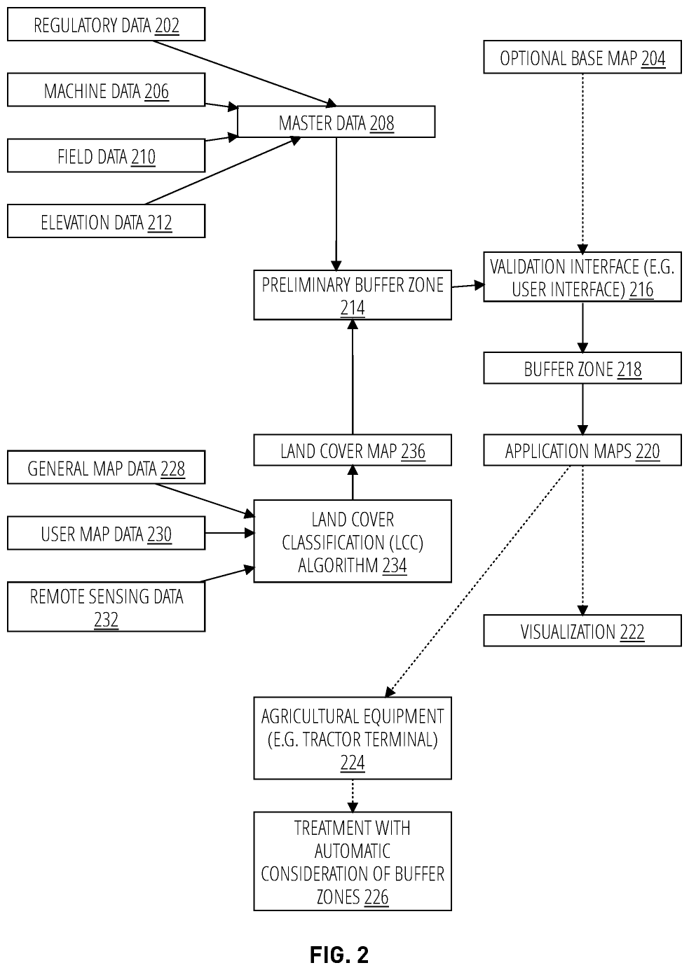

An exemplary workflow of the invention is described in the FIGS. 1 and 2.

FIG. 1 can be described as follows: The land cover map 136 is generated via the land cover classification algorithm (in the following referred to as “LCC algorithm”) 134 based on a least one of the following categories of data: General map data 120, remote sensing data 132, and user map data 130. The land cover map 136 may be optionally inputted into a validation interface (e.g. user interface) 112, which is configured to receive validation information relating to the field to be treated or relating to the land cover map 136, before the land cover map is further processed as a further layer to determine the buffer zones 110. The buffer zones 110 as a further layer to the land cover map 136 are determined based on the master data 106, or such determination is initiated. The master data 106 selected from the group consisting of regulatory data 102, machine data 104, field data 114, elevation data 116 may be optionally inputted into a validation interface (e.g. user interface) 108, which is configured to receive validation information relating to the master data 106, before the master data are 110 further processed to determine the buffer zones 110. Based on the buffer zones 110, application maps 122 specifying areas for treating the field with an agricultural equipment are generated. Optionally, the application maps 122 may be inputted into an agricultural equipment (e.g. tractor terminal) 126, which may conduct treatment 128 of an agricultural field with automatic consideration of buffer zones. Optionally, the application maps 122 can also be used for visualization 124.

FIG. 1 can be described as follows: The land cover map 136 is generated via the land cover classification algorithm (in the following referred to as “LCC algorithm”) 134 based on a least one of the following categories of data: General map data 120, remote sensing data 132, and user map data 130. The land cover map 136 may be optionally inputted into a validation interface (e.g. user interface) 112, which is configured to receive validation information relating to the field to be treated or relating to the land cover map 136, before the land cover map is used as a further layer to determine the buffer zones 110. The master data 106 selected from the group consisting of regulatory data 102, machine data 104, field data 114, elevation data 116 may be optionally inputted into a validation interface (e.g. user interface) 108, which is configured to receive validation information relating to the master data 106, before the master data 110 are used to determine the buffer zones 110. The buffer zones 110 are determined as a further layer to the land cover map 136 based on the master data 106, or such determination is initiated. Based on the buffer zones 110, application maps 122 specifying areas for treating the field with an agricultural equipment are generated. Optionally, the application maps 122 may be inputted into an agricultural equipment (e.g. tractor terminal) 126, which may conduct treatment 128 of an agricultural field with automatic consideration of buffer zones. Optionally, the application maps 122 can also be used for visualization 124. An optional base map may be inputted into the validation interface (e.g. user interface) 112.

FIG. 2 can be described as follows: The land cover map 236 is generated via the land cover classification algorithm (in the following referred to as “LCC algorithm”) 234 based on a least one of the following categories of data: General map data 228, remote sensing data 232, and user map data 230. The land cover map 236 is used as a further layer to determine the preliminary buffer zones 214. The master data 208 selected from the group consisting of regulatory data 202, machine data 206, field data 210, elevation data 212 are used to determine the preliminary buffer zones 214. The preliminary buffer zones 214 are determined as a further layer to the land cover map 236 based on the master data 208, or such determination is initiated. The preliminary buffer zones 214 are inputted into a validation interface (e.g. user interface) 216, which is configured to receive validation information relating to the preliminary buffer zones 214. The buffer zones 218 are then determined based on the validation information relating to the preliminary buffer zones 214. Based on the buffer zones 218, application maps 220 specifying areas for treating the field with an agricultural equipment are generated. Optionally, the application maps 220 may be inputted into an agricultural equipment (e.g. tractor terminal) 224, which may conduct treatment 226 of an agricultural field with automatic consideration of buffer zones. Optionally, the application maps 220 can also be used for visualization 222. An optional base map may be inputted into the validation interface (e.g. user interface) 216.

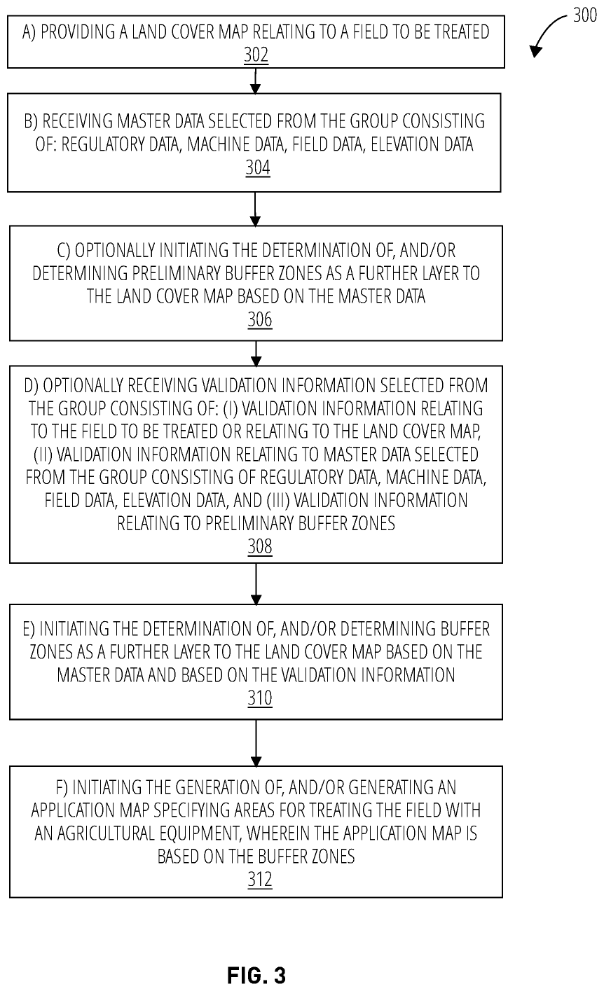

FIG. 3 illustrates the computer-implemented method of the present invention. In the step (302), a land cover map relating to a field to be treated is provided. In the step (304), master data selected from the group consisting of regulatory data, machine data, field data, elevation data are received. In the optional step (306), the preliminary buffer zones are determined as a further layer to the land cover map based on the master data, and/or such determination is initiated. In the optional step (308), validation information selected from the group consisting of:

(i) validation information relating to the field to be treated or relating to the land cover map,
(ii) validation information relating to master data selected from the group consisting of regulatory data, machine data, field data, elevation data,
(iii) validation information relating to preliminary buffer zones, is received. In the step (310), the buffer zones are determined as a further layer to the land cover map based on the master data and based on the validation information, and/or such determination is initiated. In the step (312), an application map is generated specifying areas for treating the field with an agricultural equipment, wherein the application map is based on the buffer zones, and/or such generation of an application map is initiated.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer-implemented method for generating an application map for treating a field with an agricultural equipment comprising the following steps:
a) (302) providing a land cover map relating to a field to be treated;
b) (304) receiving master data selected from the group consisting of: regulatory data, machine data, field data, elevation data;
e) (310) initiating the determination of, and/or determining buffer zones as a further layer to the land cover map based on the master data; and
f) (312) initiating the generation of, and/or generating an application map specifying areas for treating the field with an agricultural equipment, wherein the application map is based on the buffer zones.

2. Computer-implemented method according to claim 1, comprising the following steps:
a) (302) providing a land cover map relating to a field to be treated;
b) (304) receiving master data selected from the group consisting of: regulatory data, machine data, field data, elevation data;
c) (306) optionally initiating the determination of, and/or determining preliminary buffer zones as a further layer to the land cover map based on the master data (306);
d) (308) optionally receiving validation information selected from the group consisting of:
(i) validation information relating to the field to be treated or relating to the land cover map,
(ii) validation information relating to master data selected from the group consisting of regulatory data, machine data, field data, elevation data, and
(iii) validation information relating to preliminary buffer zones;
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

3. Computer-implemented method according to claim 1, comprising the following steps:
a) (302) providing a land cover map relating to a field to be treated;
b) (304) receiving master data selected from the group consisting of: regulatory data, machine data, field data, elevation data;
c) (306) optionally initiating the determination of, and/or determining preliminary buffer zones as a further layer to the land cover map based on the master data (306);
d) (308) receiving validation information selected from the group consisting of:
(i) validation information relating to the field to be treated or relating to the land cover map,
(ii) validation information relating to master data selected from the group consisting of regulatory data, machine data, field data, elevation data, and
(iii) validation information relating to preliminary buffer zones;
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

4. Computer-implemented method according to claim 1, comprising the following steps:
a) (302) providing a land cover map relating to a field to be treated;
b) (304) receiving master data selected from the group consisting of: regulatory data, machine data, field data, elevation data,
d) (308) receiving validation information relating to the field to be treated or relating to the land cover map,
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

5. Computer-implemented method according to claim 1, comprising the following steps:
a) (302) providing a land cover map relating to a field to be treated;
b) (304) receiving master data selected from the group consisting of: regulatory data, machine data, field data, elevation data;
d) (308) receiving validation information relating to master data selected from the group consisting of regulatory data, machine data, field data, elevation data;
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

6. Computer-implemented method according to claim 1, comprising the following steps:
a) (302) providing a land cover map relating to a field to be treated;
b) (304) receiving master data selected from the group consisting of: regulatory data, machine data, field data, elevation data;
c) (306) initiating the determination of, and/or determining preliminary buffer zones as a further layer to the land cover map based on the master data;
d) (308) receiving validation information relating to preliminary buffer zones;
e) (310) initiating the determination of, and/or determining buffer zones as a further layer to the land cover map based on the master data and based on the validation information; and
f) (312) initiating the generation of, and/or generating an application map specifying areas for treating the field with an agricultural equipment, wherein the application map is based on the buffer zones.

7. Computer-implemented method according to claim 1, wherein the land cover map is generated based on a least one of the following categories of data: general map data, remote sensing data and user map data.

8. Computer-implemented method according to claim 1, wherein the land cover map is generated via a land cover classification algorithm.

9. Computer-implemented method according to claim 1, wherein the master data include regulatory data, machine data, and field data.

10. Computer-implemented method according to claim 1, wherein the master data include machine data.

11. Computer-implemented method according to claim 1, wherein the master data include regulatory data.

12. Computer-implemented method according to claim 2, wherein the validation information includes at least one of the following information:
1) information that all data relating to the field to be treated or all objects shown in the land cover map is correct;
2) information that specific data relating to the field to be treated have to be corrected;
3) information that specific objects in the land cover map have to be either added, or modified, or deleted.

13. Computer-implemented method according to claim 2, wherein the validation information includes at least one of the following information:
1) information that all master data are correct;
2) information that specific master data have to be corrected;
3) information that specific master data have to be either added, or modified, or deleted.

14. Computer-implemented method according to claim 2, wherein the validation information includes at least one of the following information:
1) information that all preliminary buffer zones and/or all objects shown in the preliminary buffer zones are correct;
2) information that specific preliminary buffer zones and/or specific objects shown in the preliminary buffer zones have to be corrected;
3) information that specific preliminary buffer zones and/or specific objects shown in the preliminary buffer zones have to be either added, or modified, or deleted.

15. Computer-implemented method according to claim 2, wherein the validation information is inputted by the human user.

16. Computer-implemented method according to claim 2, wherein the validation information relating to the field to be treated or relating to the land cover map is inputted by a sensor or machine which is capable of automatically or semi-automatically obtaining data relating to the field to be treated or recognizing objects shown in the land cover map.

17. Computer-implemented method according to claim 2, wherein the validation information relating to the master data is inputted sensor or machine which is capable of automatically or semi-automatically obtaining master data.

18. Computer-implemented method according to claim 2, wherein the validation information relating to the preliminary buffer zone is inputted sensor or machine which is capable of automatically or semi-automatically obtaining data relating to the preliminary buffer zone.

19. Agricultural equipment configured to be controlled by control data and/or a control map provided by a method according to claim 1.

20. A computer system for generating an application map for treating a field with an agricultural equipment comprising:
1) a first interface component configured to provide a land cover map relating to a field to be treated,
2) a second interface component configured to receive master data selected from the group consisting of: regulatory data, machine data, field data, elevation data;
3) optionally a third interface component configured to initiate the determination of, and/or a first system module configured to determine preliminary buffer zones as a further layer to the land cover map based on the master data;
4) optionally a fourth interface component configured to receive validation information selected from the group consisting of:
(i) validation information relating to the field to be treated or relating to the land cover map,
(ii) validation information relating to master data selected from the group consisting of regulatory data, machine data, field data, elevation data,
(iii) validation information relating to preliminary buffer zones;
5) a fifth interface component configured to initiate the determination of, and/or a second system module configured to determine buffer zones as a further layer to the land cover map based on the master data and based on the validation information; and
6) a sixth interface component configured to initiate the generation of, and/or a third system module configured to generate an application map specifying areas for treating the field with an agricultural equipment, wherein the application map is based on the buffer zones.
